(19) United States
(12) Patent Application Publication
(10) Pub. No.: US 2007/0076982 A1
(43) Pub. Date: Apr. 5, 2007

(54) System and method for video stabilization

(76) Inventor: Doina I. Petrescu, Vernon Hills, IL (US)

Correspondence Address: MOTOROLA INC, 600 NORTH US HIGHWAY 45, ROOM AS437, LIBERTYVILLE, IL, 60048-5343, US

(21) Appl. No.: 11/241,666

(22) Filed: Sep. 30, 2005

(51) Int. Cl. G06K 9/32

(52) U.S. Cl. 382/294; 382/295

(57) ABSTRACT

Disclosed is a method and circuit for stabilizing unintentional motion within an image sequence generated by an image capturing device (102). The image sequence is formed from a temporal sequence of frames, each frame (202) having an area and an outer boundary. The images are two dimensional arrays of pixels. The area of the frames is divided into a foreground area portion (204) and background area portion (206). From the background area portion of the frames, a background pixel domain is selected for evaluation (404). The background pixel domain is used to generate an evaluation (406), for subsequent stabilization processing (408), calculated between corresponding pairs of a sub-sequence of select frames.

### FIELD OF THE INVENTION

The present invention relates to video image processing, and more particularly to video processing to stabilize unintentional image motion.

### BACKGROUND OF THE INVENTION

Image capturing devices, such as digital video cameras, are being increasingly incorporated into handheld devices such as wireless communication devices. Users may capture video on their wireless communication devices and transmit a file to a recipient via a base transceiver station. It is common that the image sequences contain unwanted motion between successive frames in the sequence. In particular, hand-shaking introduces undesired global motion in video captured with a camera incorporated into a handheld device such as a cellular telephone. Other causes of unwanted motion can include vibrations, fluctuations or micro-oscillations of the image capturing device during the acquisition of the sequence.

As wireless mobile device technology has continued to improve, the devices have become increasingly smaller. Accordingly, image capturing devices such as those included in wireless communication devices can have more restricted processing capabilities and functions due to tighter size constraints. While there are prior compensation techniques, which attempt to correct for any “jitter,” the processing instructions often require the analysis of relatively larger amounts of data and higher amounts of processing power. In particular, users of wireless communication devices, which have image capturing devices, oftentimes multi-task their devices so processing of video with processor intensive compensation techniques may slow other applications, or may be impeded by other applications.

### BRIEF DESCRIPTION OF THE DRAWINGS

FIG. 1 shows an exemplary embodiment of a wireless communication device having image capturing capabilities;

FIG. 2 represents a single frame in a sequence of frames;

FIG. 3 shows two sequence frames in time, both having corner sectors;

FIG. 4 is a flowchart illustrating an embodiment of the method as described herein; and

FIG. 5 shows steps of the evaluation and stabilization processes.

### DETAILED DESCRIPTION OF THE INVENTION

Disclosed is a method and circuit for stabilizing motion within an image sequence generated by an image capturing device. The image sequence is formed from a temporal sequence of frames, each frame having an area. The images are commonly two dimensional arrays, of pixels. The area of the frames generally can be divided into a foreground area portion and background area portion. From the background area portion of the frames, a background pixel domain is selected for evaluation. The background pixel domain is used to generate an evaluation, for subsequent stabilization processing, calculated between corresponding pairs of a sub-sequence of select frames. In one embodiment, the corner sectors of the frames of the sequence of frames are determined and the background pixel domain is formed to correspond to the corner sectors. Stabilization processing is applied based on the evaluation of the frames in the sequence of frames. Described are compensation methods and a circuit for stabilizing involuntary motion using a global motion vector calculation while preserving constant voluntary camera motion such as panning.

The instant disclosure is provided to further explain in an enabling fashion the best modes of making and using various embodiments in accordance with the present invention. The disclosure is further offered to enhance an understanding and appreciation for the invention principles and advantages thereof, rather than to limit in any manner the invention. The invention is defined solely by the appended claims including any amendments of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions. Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts within the preferred embodiments.

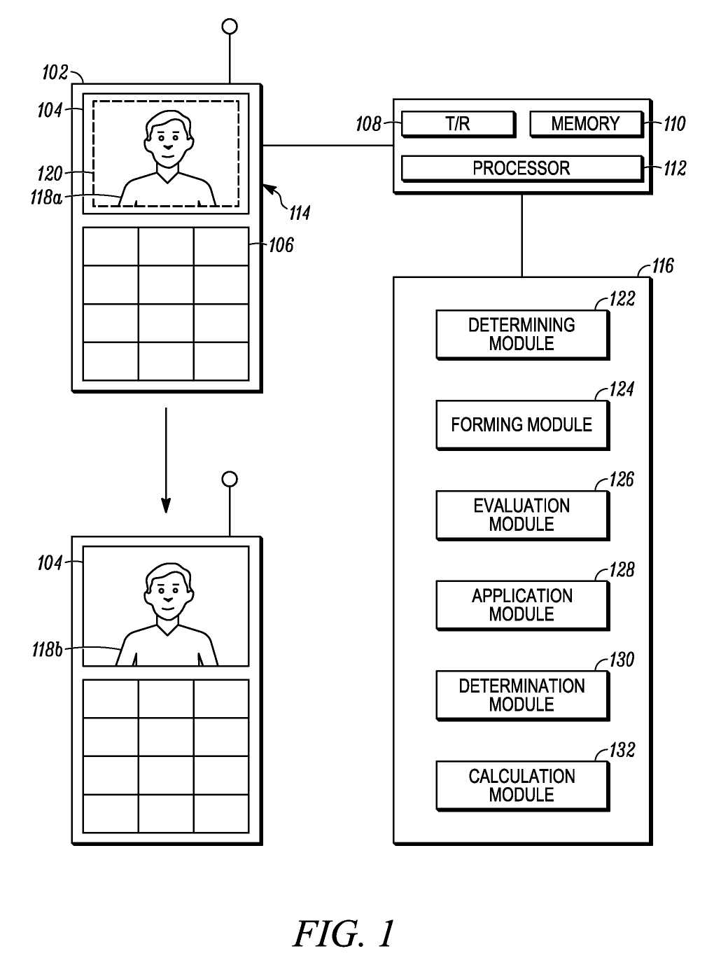

FIG. 1 shows an embodiment of a wireless communication device 102 having image capturing capabilities. The device 102 represents a wide variety of handheld devices including communication devices, which have been developed for use within various networks. Such handheld communication devices include, for example, cellular telephones, messaging devices, mobile telephones, personal digital assistants (PDAs), notebook or laptop computers incorporating communication modems, mobile data terminals, application specific gaming devices, video gaming devices incorporating wireless modems, and the like. Any of these portable devices may be referred to as a mobile station or user equipment. Herein, wireless and wired communication technologies include the capability of transferring high content data. For example, the mobile communication device 102 can provide Internet access and multi-media content access, and can also transmit and receive video files.

The application of image stabilization in mobile phone cameras can differ from its application in video communications or camcorders because phone cameras have reduced picture sizes due to small displays, which consist of smaller numbers of pixels, different frame rates, and a demand of low computation complexity. While an image capturing device is discussed herein with respect to a handheld wireless communication device, the image capturing device can be equally applicable to stand alone devices, which may not incorporate a communication capability, wireless or otherwise, such as a camcorder or a digital camera. It is further understood that an image capturing device may be incorporated into still further types of devices, where upon the present application may be applicable. Still further, the present application may be applicable to devices, which perform post capture image processing of images with or without image capture capability, such as a personal computer, upon which a sequence of images may have been downloaded.

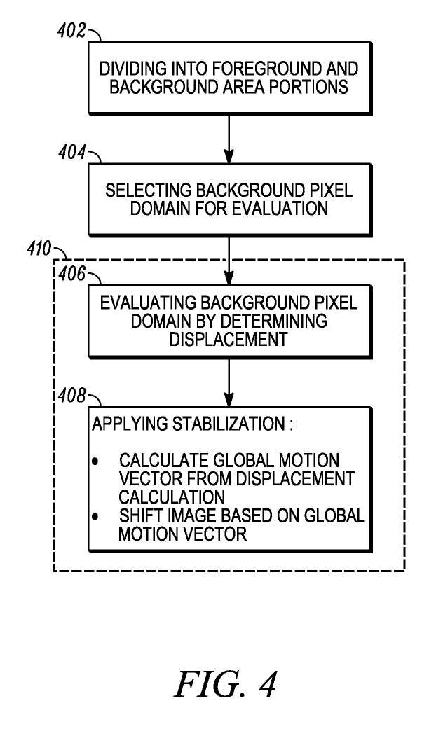

Sequential images and other display indicia to form video may be displayed on the display device 104. The device 102 includes input capability such as a key pad 106, a transmitter and receiver 108, a memory 110, a processor 112, camera 114 (the arrow in FIG. 1 indicating that the aperture for the camera is on the reverse side of device 102), and modules 116 that can direct the operation of at least some aspects of the device that are hardware (i.e. logic gates, sequential state machines, etc.) or software (i.e. one or more sets of prestored instructions, etc.). Modules 116 are described in detail below in conjunction with the discussion of FIG. 4. While these components of the wireless communication device are shown as part of the device, any of their functions in accordance with this disclosure may be accomplished by transmission to and reception from, wirelessly or via wires, electronic components, which are remote from the device 102.

The described methods and circuits are applicable to video data captured by an image capturing device. Video not previously processed in accordance with the methods and circuits described herein may be sent to a recipient and the recipient can apply the described methods and circuits to the unprocessed video in order to stabilize the motion. Accordingly, the instant methods are applicable to the video files at any stage. Prior to storage, after storage and after transmission, the instant methods and circuits may effect stabilization.

Communication networks to transmit and receive video may include those used to transmit digital data through radio frequency links. The links may be between two or more devices, and may involve a wireless communication network infrastructure including base transceivers stations or any other configuration. Examples of communication networks are telephone networks, messaging networks, and Internet networks. Such networks can include land lines, radio links, and satellite links, and can be used for such purposes as cellular telephone systems, Internet systems, computer networks, messaging systems and satellite systems, singularly or in combination.

Still referring to FIG. 1, as described herein, automatic image stabilization can remove the effects of undesired motion (in particular, jitter associated with the movement of one's hand) when taking pictures or videos. There are two major effects produced by the inability to hold a hand-held camera in a steady position without mechanical stabilization from, for example, a tripod. First, when taking a picture of high resolution the image capture takes up to a few seconds and handshaking results in a blurred picture. Second, when shooting a video, handshaking produces undesired global picture movement.

The undesired image motion may be represented as rotation and/or translation with respect to the camera lens principal axis. The frequency of the involuntary hand movement is usually around 2 Hz. As described below in detail, stabilization can be performed for the video background, when a moving subject is in front of a steady background. By evaluation of the background instead of the whole images of the image sequence, unintentional motion is targeted for stabilization and intentional (i.e. desired) motion may be substantially unaffected. In another embodiment, stabilization can be performed for the video foreground, when it is performed for the central part of the image where the close to perfect in-focus is achieved.

Still referring to FIG. 1, an unprocessed image 118a of a person is shown displayed on display screen 104. Below a processed image 118b of an extracted sub-image is shown on display screen 104. Processed image 118b shows that the outer boundary 120 of the image 118a has been eliminated. As will be discussion in greater detail below, the evaluation determines an amount of shift to be applied, by calculating displacement of portions of the image which are not expected to move, and the stabilization shifts the images of sequential frames, thus eliminating at least a portion of the outer boundary.

In particular, when the image composition includes a center subject as shown by images 118a and 118b, the frames can include an outer boundary from which a buffer region is formed. The buffer may include portions or all of the outer boundary. The buffer may be referred to as a background pixel domain below. The buffer region is used during the stabilization processing to supply image information including spare row data and column data which are needed for any corrective translations, when the image is shifted to correct for unintentional jitter between frames.

In stabilization, data originally forming part of the buffer outside the outer boundary 120 is reintroduced as part of the stabilized image in varying degrees across a sequence of frames. The position of the adjusted outer boundary is determined, when a global motion vector (described below) for the image is calculated. In at least some embodiments, the motion compensation (i.e. the shift) can be performed by changing the location in memory from which image data is read, and changing the amount of memory read out to display image data. In other words, stabilization takes place when compensation is performed by changing the starting address and extent of the displayed image within the larger captured image. After scaling the image to fill the display, the result as shown is an enlarged image 118b. Alternatively, the cut-out stabilized image can be zoomed back to the original size for display so that it appears as that shown as image 118a.

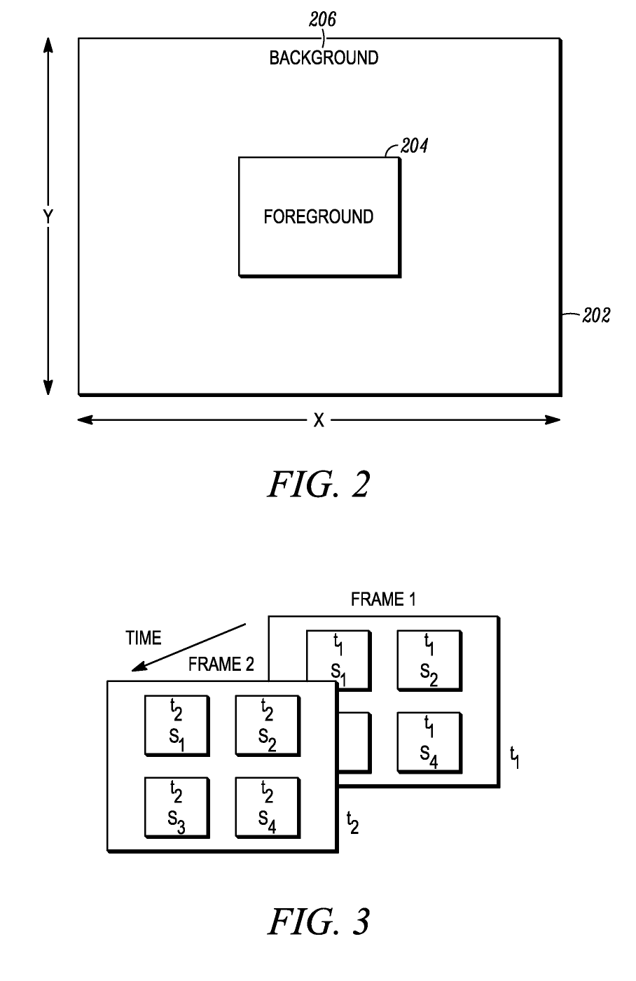

FIG. 2 shows a single frame having an area 202 equal to the horizontal axis multiplied by the vertical axis. As discussed above, the image sequence is formed from a temporal sequence of frames, each frame having an area. The area of the frames is divided into one or more foreground area portions 204 and one or more background area portions 206 in an image that corresponds to the one shown in FIG. 1 in composition. In the illustrated embodiment, the foreground pixel domain substantially corresponds to the inner area portion, and the background pixel domain substantially corresponds to the outer boundary. However, the foreground and background may be reversed, or side-by-side, or in any configuration depending upon the composition of the image. In other words, the foreground portion generally includes the portion of the image, which is the principal subject of the captured image, and is more likely to have intended movement between temporally sequential frames. The background portion generally includes portions of the image, which are stable or pan across at a deliberate rate.

For evaluation and stabilization processing, the background may be distinguished from the foreground in different manners, a number of which are described herein. In at least some embodiments, the background may be determined by isolating corner sectors of the frames of the sequence of frames and then forming the background pixel domain to correspond to the corner sectors. A predetermined number of background pixel domains, such as corner sectors may be included.

Briefly turning to FIG. 3, there are four corner sectors shown. It may be preferred to manually divide the area of the frames into sub-areas including a foreground area portion and background area portion. In any case, the foreground and the background may include different types and/or amounts of motion. The background which is otherwise substantially static (or moving substantially uniformly), can be used to more readily identify and/or isolate motion consistent with hand motion. The foreground may include additional motion, for example, the motion of a person in conversation. Accordingly, in another embodiment, the background area portion can be located by locating a sub-area having a motion amplitude value that is below a predetermined threshold value, such as that corresponding to hand motion. In another embodiment, selecting the background pixel domain includes locating one or more sub-areas that are substantially static or moving substantially uniformly between evaluated frames. Alternatively, dividing the area of frames may be provided by locating a sub-area having motion which corresponds to the foreground area.

FIG. 2 represents a single frame in a sequence of frames. In a standard configuration as shown in FIG. 2, a background pixel domain is selected for evaluation from the background area portion of the frames. The background pixel domain is used to generate an evaluation. Subsequent stabilization processing can be calculated between corresponding pairs of a sub-sequence of select frames.

FIG. 3 shows two frames in time, both having corner sectors. Sub-images in this example are corner sectors S1, S2, S3 and S4, and correspond to potential background area portions of the image. FIG. 3 further illustrates that frame 1 and frame 2 are a temporal sequence of frames. It is understood that a sequence of frames can include more than two frames. A subsequence of select frames can include consecutive select frames. A subsequence of select frames may also include alternating or frames selected using any desired criteria, where the resulting selected frames have a known time displacement. It is further understood that any selection of frames is within the scope of this discussion. Generally, frames in the subsequence may retain their sequential order. In FIG. 3, frame 1 is generated at time t₁, and frame 2 is generated at time t₂, with t₂>t₁. The evaluation of the sub-images for the stabilization of a sequence of frames will be discussed in more detail below.

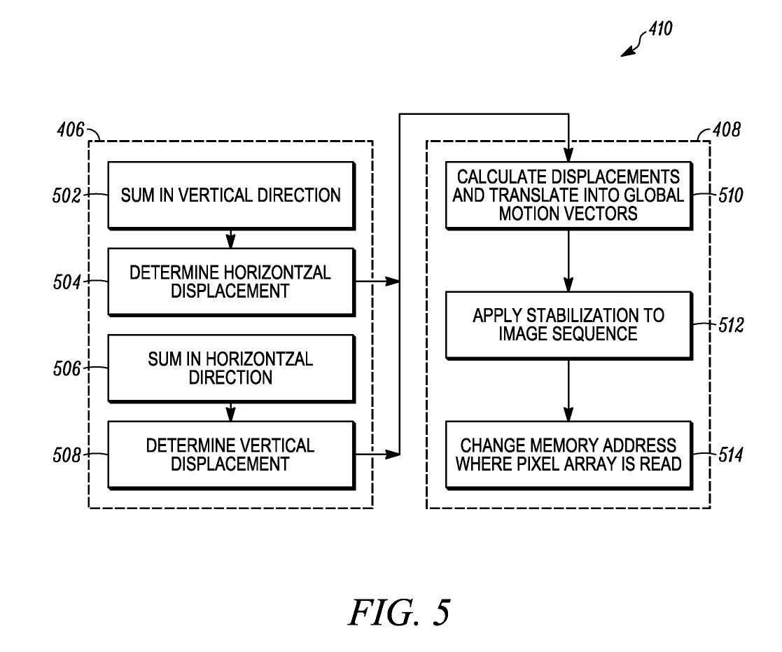

FIG. 4 is a flowchart illustrating an embodiment of the method as described herein. As discussed above, the image is divided into foreground and background area portions 402. From the background area the background pixel domain is selected for evaluation 404. Four corners can be selected as shown in FIG. 3. As will be discussed in more detail below, the background pixel domain, here, four corners, is evaluated for application of stabilization 406. That is, evaluation includes summation and displacement determination. Then stabilization which includes calculating a global motion vector and applying a shift of the corresponding image in the image sequence 408. Evaluation 406 and stabilization 408 are grouped together 410, to be discussed further in connection with FIG. 5 below. It is understood, that the order of the steps described herein may be ordered differently to arrive at the same result.

Similarly, modules are shown in FIG. 1 that can carry out the method. Hardware (such as circuit components) or software modules 116, or a combination of both, can include a determining module 122 for determining the background portion of the frames. The modules further include a forming module 124 for forming a background pixel domain from the background portion, an evaluation module 126 for evaluating the background pixel domain to generate an evaluation for subsequent stabilization processing and an application module 128 for applying stabilization processing based on the evaluation to the area of the frames of the sequence of frames. Additionally, FIG. 1 shows a determination module 130 to carry out the steps of determining horizontal displacement components of the vertical pixel columns and the vertical displacement components of the horizontal pixel rows of the frames of the sequence of frames to generate the evaluation. Also shown is a calculation module 132 for calculating a global motion vector by determining an average of middle range values for the horizontal displacement components and an average of middle range values for the vertical displacement components.

FIG. 5 shows more details of steps of the evaluation 406 and stabilization 408 processes of FIG. 4. The step of evaluation of the background pixel domain 406 includes calculating displacement components of elements within the pixel groupings. The frames include pixels, typically arranged in two dimensional (for example, horizontal and vertical) pixel arrays. In this embodiment, displacement components include a pair of substantially orthogonal displacement vectors. Pixels may also be disposed in other regular or irregular arrangements. It will be understood that the steps of the method disclosed herein may readily be adapted to any pixel arrangement. In the embodiment discussed herein, corner sectors include orthogonal pixel arrays. To calculate displacement components, the pixel values in a vertical direction are summed 502 to determine a horizontal displacement vector 504, and the pixel values in a horizontal direction are summed 506 to determine a vertical displacement vector 508.

Apparent displacement between pixel arrays in the background pixel domain of a temporal sequence of frames is an indication of motion. Such apparent displacement is determined by the above-described calculation of horizontal and vertical displacement vectors. By considering displacement of the background pixel domain instead of the entire area, low computational complexity can be provided. In stabilization 408, the result of the background pixel domain displacement calculations 510 can then be translated into global motion vectors to be applied to the image as a whole 512 for the sequence of frames. Applying stabilization processing based on the background evaluation includes calculating a global motion vector for application to the frames 510. Calculating the global motion vector includes determining an average of middle range values for the vertical displacements components and an average of middle range values for the horizontal displacement components. In stabilization, compensating for displacement includes shifting the image and reusing some or all of the outer boundary as part of the stabilized image by changing the address in memory from which the pixel array is read 514.

Below is a more detailed description of certain aspects of the methods and circuits described above. Prior to the evaluation 406, picture pre-processing can be performed on the captured image frame to enhance or extract the information which will be used in the motion vector estimation. The pixel values may be formatted according to industry standards. For example, when the picture is in Bayer format the green values are generally used for the whole global motion estimation process. Alternatively, if the picture is in YCbCr format, the luminance (Y) data can be used. Pre-processing may include a step of applying a band-pass filter on the image to remove high frequencies produced by noise and the low frequencies produced by flicker and shading.

In the evaluation 406, two projection pixel arrays are generated from the background area portions, particularly sub-images of the image data (see FIG. 3). Projection pixel arrays are created by projecting onto one-dimensional arrays, two-dimensional pixel values, by summing the pixels which have in the sub-image a particular horizontal index, thus resulting in a projection onto the horizontal axis of the original two-dimensional sub-image. A corresponding process is performed for the vertical index. Accordingly, one projection pixel array is composed of the sums of values along each column and the other projection pixel array is composed of the sums of values along each row as represented in the following mathematical formulae:

$${X}^{′} ( j ) = {\sum }_{y} {S}^{′} ( j , y ) , for j = 1 to the number of columns in the image , \\ {Y}^{′} ( i ) = {\sum }_{x} {S}^{′} ( j , y ) , for i = 1 to the number of rows in the image .$$

A sub-image can be shifted relative to the corresponding sub-image in a preceding select frame by ±N pixels in the horizontal direction and by ±M pixels in the vertical direction, or by any number of pixels between these limits. The set of shift correspondences between sub-images of select frames constitutes candidate motion vectors. For each candidate motion vector, the value of an error criterion can be determined as described below.

An error criterion can be defined and calculated between two consecutive corresponding sub-images for various motion vector candidates. The candidates can correspond to a (2M+1) pixel×(2N+1) pixel search window. There is a search window for each sub-image. The search window can be larger than the sub-image by the amount of the buffer region. The search window can be square although it may take any shape. The candidate providing the lowest value for the error criterion can be used as the motion vector of the sub-image. The accuracy of the determination of motion may depend on the number of candidates investigated and the size of the sub-image. The two projection arrays (for rows and columns) can be used separately and the error criterion which is the sum of absolute differences is calculated for 2N+1 shift values for the horizontal candidates, and calculated for 2M+1 shift values for the vertical candidates.

$${C}_{k}^{X} ( j ) = {\sum }_{x} \vert X ( x ) - X ( x + j ) \vert$$

$${C}_{k}^{Y} ( j ) = {\sum }_{y} \vert Y ( y ) - Y ( y + j ) \vert$$

The horizontal shift minimizing the criterion for the array of column sums (Cₖ^{X}) can be chosen as the horizontal component of the sub-image motion vector. The vertical shift minimizing the criterion for the array of row sums (Cₖ^{y}) can be chosen as the vertical component of the sub-image motion vector.

From the sub-image motion vectors, the median value for the horizontal component and the median value for the vertical component may be chosen. Choosing the median value may eliminate impulses and unreliable motion vectors from areas with local motion different from the global motion that behave like impulses. The sub-image motion vectors and the global motion vector of the previous frame may furthermore be used to produce the output. The previous frame global motion vector can be used as a basis for subsequent frame global motion vecors, because it can be expected that two consecutive frames will have similar motion. For the case of four sub-images the global image motion vector (V_{g}) is calculated as:
V_{g}^{t}=median{V₁^{t},V₂^{t},V₃^{t},V₄^{t},V₈^{t-1}}
where V₁^{t}, V₂^{t}, V₃^{t}, and V₄^{t} are the motion vectors chosen for the four sub-images. It is understood that “t” and “t−1” are used herein for notational convenience and not to connote that immediately consecutive frames be used necessarily. As mentioned previously, alternating frames or other choices for a subsequence of frames may be used, and are within the scope of this disclosure.

Also, a procedure can be used to evaluate camera motion from the beginning of the capture and make the compensation adaptive to intentional camera motion, such as panning. This method includes calculating an integrated motion vector that is a linear combination of the current motion vector and previous motion vectors with a damping coefficient. The integral motion vector converges to zero when there is no camera motion.
Vᵢ(t)=k*Vᵢ(t−1)+V_{g}(t) (2)

In the above equation Vᵢ denotes the integrated motion vector for estimating camera motion and V_{g} denotes the global motion vector for the consecutive pictures at moments (t−1) and t. The damping coefficient k can be selected to have a value between 0.9 and 0.999 to achieve smooth camera motion compensation for hand shaking caused jitter while adapting to intentional camera motion (panning).

In addition to the subjective improvement of the observed sequence, another aspect of video stabilization is the ability to reduce bit rate for encoding the stabilized sequence. The global motion vector calculated during stabilization may improve motion compensation and reduce the amount of residual data which needs to be discrete cosine transform (DCT) coded. Two different scenarios are considered when combining the stabilization with video encoding. First, stabilization can be performed prior to the video encoding, as a separate preprocessing step, and stabilized images are used by the video encoder. Second, stabilization becomes an additional stage within the video encoder, where global motion information is extracted from the already previously calculated motion vectors and then the global motion is used in further encoding stages.

As described in detail above, global motion vectors can be defined as two dimensional (horizontal and vertical) displacements from one frame to another, evaluated from the background pixel domain by considering sub-images. Furthermore, an error criterion is defined and the value of this criterion is determined for different motion vector candidates. The candidate having the lowest value of the criterion can be selected as the result for a sub-image. The most common criterion is the sum of absolute differences. A choice for motion vectors for horizontal and vertical directions can be calculated separately, and the global two dimensional motion vector can be defined using these components. For example, the median horizontal value, among the candidates chosen for each sub-image, and the median vertical value, among the candidates chosen for each sub-image, can be chosen as the two components of the global motion vector. The global motion can thus be calculated by dividing the image into sub-images, calculating motion vectors for the sub-images and using an evaluation or decision process to determine the whole image global motion from the sub-images. The images of the sequences of images can be accordingly shifted, a portion or all of the outer boundary being eliminated, to reduce or eliminate unintentional motion of the image sequence.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitable entitled.

1. A method for stabilizing elements within an image sequence formed from a temporal sequence of frames, each frame having an area, the image sequence generated by an image capturing device, the method comprising:
dividing the area of the frames of the sequence of frames into sub-areas comprising a foreground area portion and background area portion;
selecting a background pixel domain for evaluation from the background area portion of the frames;
evaluating the background pixel domain to generate an evaluation for subsequent stabilization processing calculated between corresponding pairs of a sub-sequence of select frames; and
applying stabilization processing based on the evaluation to the frames of the sequence of frames.

2. A method as recited in claim 1 wherein prior to applying the stabilization processing, the frames comprise an outer boundary from which a buffer region is formed, wherein the buffer region is used during the stabilization processing to supply image information including spare row data and column data.

3. A method as recited in claim 1 wherein the sub-sequence of select frames comprises consecutive select frames.

4. A method as recited in claim 1 wherein selecting the background pixel domain from the background area portion in the frames, comprises:
determining corner sectors of the frames of the sequence of frames; and
forming the background pixel domain to correspond to the corner sectors.

5. A method as recited in claim 1 wherein selecting the background pixel domain from the background area portion in the frames comprises:
determining a center sector substantially corresponding to the foreground area portion; and
forming the background pixel domain to substantially correspond to an area portion in the frames of the sequence of frames outside the center sector.

6. A method as recited in claim 1 wherein selecting further comprises selecting a plurality of background pixel domains from the background area portion in the frames of the sequence of frames, the method comprising:
selecting a predetermined number of background pixel domains.

7. A method as recited in claim 1 wherein selecting further comprises selecting a plurality of background pixel domains from the background area portion in the frames of the sequence of frames, the method comprising:
selecting four background pixel domains.

8. A method as recited in claim 1 wherein a background pixel domain comprises select pixel groupings, and wherein evaluating the background pixel domain for subsequent stabilization processing, comprises:
calculating displacement components of elements within the pixel groupings to generate the evaluation.

9. A method as recited in claim 8 wherein the displacement components include a pair of substantially orthogonal displacement vectors.

10. A method as recited in claim 8 wherein the pixel arrays comprise pixel values, and wherein calculating displacement components comprises:
summing the pixel values in a vertical direction to determine a horizontal displacement vector; and
summing the pixel values in a horizontal direction to determine a vertical displacement vector.

11. A method as recited in claim 10 wherein applying stabilization processing based on the evaluation, comprises:
calculating a global motion vector by determining an average of middle range values for the vertical displacements components and an average of middle range values for the horizontal displacement components.

12. A method as recited in claim 1 wherein dividing the area of the frames of the sequence of frames into sub-areas comprising a foreground area portion and background area portion is performed manually.

13. A method as recited in claim 1 wherein dividing the area of frames of a sequence of frames into sub-areas comprising a foreground area portion and background area portion, comprises:
determining the background area portion by locating a sub-area comprising a motion amplitude value that is below a predetermined threshold value.

14. A method as recited in claim 1 wherein selecting the background pixel domain comprises;
locating one or more sub-areas that are substantially uniformly static between evaluated frames.

15. A method as recited in claim 1 wherein dividing the area of frames of a sequence of frames into sub-areas comprising a foreground area portion and background area portion, comprises:
determining the foreground area portion by locating a sub-area having motion.

16. A method as recited in claim 1, comprising:
processing the dividing, selecting, evaluating and applying steps while the frames in the image sequence formed from the temporal sequence are being generated by the image capturing device.

17. A method for stabilizing elements within an image sequence formed from a temporal sequence of frames, each frame having an area, the image sequence generated by an image capturing device, the method comprising:
determining boundary regions of the frames of the sequence of frames;
selecting the boundary regions for evaluation of the frames;
evaluating the corresponding selected boundary regions to generate an evaluation for subsequent stabilization processing calculated between corresponding pairs of a sub-sequence of select frames; and
applying stabilization processing based on the evaluation to the frames of the sequence of frames.

18. A method as recited in claim 17, wherein the selected boundary regions comprise one or more corner sectors.

19. A method as recited in claim 17, wherein the selected boundary region is substantially comprised of background area portions.

20. A method as recited in claim 18 wherein the corner sectors comprise pixels arrayed orthogonally to form pixel arrays, and wherein evaluating the selected boundary regions for subsequent stabilization processing, comprises:
calculating displacements components of select pixel groupings within the selected boundary regions to generate the evaluation.

21. A method as recited in claim 20 wherein the pixels comprise pixel values, and wherein calculating displacement components comprises:
summing the pixel values in a vertical direction to determine horizontal displacement components; and
summing the pixel values in a horizontal direction to determine vertical displacement components.

22. A method as recited in claim 21 wherein evaluating the vertical displacements components and the horizontal displacement components, comprises:
evaluating the vertical displacement components and the horizontal displacement components separately.

23. A circuit for stabilizing an image sequence formed from a sequence of frames, each frame having an area, the image sequence generated by an image capturing device, the method comprising:
a determining module for determining corner sectors of the area of the frames of the sequence of frames;
a forming module for forming a background pixel domain to correspond to the corner sectors;
an evaluation module for evaluating the background pixel domain to generate an evaluation for subsequent stabilization processing; and
an application module for applying stabilization processing based on the evaluation to the area of the frames of the sequence of frames.

24. A system as recited in claim 23 wherein the background pixel domain comprises vertical pixel columns and horizontal pixel rows, and wherein the evaluation module comprises:
a determination module for determining vertical displacements components of the vertical pixel columns and the horizontal displacement components of the horizontal pixel rows of the frames of the sequence of frames to generate the evaluation.

25. A system as recited in claim 23 wherein the evaluation module comprises:
separate evaluation modules for evaluating the vertical displacement components and the horizontal displacement components separately.

26. A system as recited in claim 25 further comprising:
a calculation module calculating a global motion vector by determining an average of middle range values for the vertical displacements components and an average of middle range values for the horizontal displacement components.
